(19) United States
(12) Patent Application Publication
(10) Pub. No.: US 2026/0186234 A1
(43) Pub. Date: Jul. 2, 2026

(54) LENS MODULE AND CAMERA DEVICE

(71) Applicant: Luxvisions Innovation Technology Corp. Limited, Guangzhou City (CN)

(72) Inventors: Cheng-Te Tseng, Guangzhou City (CN); Shu-Hung Liu, Guangzhou City (CN); Shih-Chieh Yen, Guangzhou City (CN)

(73) Assignee: Luxvisions Innovation Technology Corp. Limited, Guangzhou City (CN)

(21) Appl. No.: 19/392,295

(22) Filed: Nov. 18, 2025

(30) Foreign Application Priority Data
Dec. 31, 2024 (CN) 202411996542.9

(51) Int. Cl. G02B 7/04

(52) U.S. Cl. CPC G02B 7/04

(57) ABSTRACT

A camera device and a lens module in the camera device are provided. The lens module includes a substrate, a photosensitive assembly, a support member, a first lens, an actuator, an outer ring member, and a second lens. The photosensitive assembly is on the substrate. The support member having a first opening is on the substrate and covers the photosensitive assembly. The first lens corresponding to the photosensitive assembly is arranged at the first opening. The actuator having a second opening is on the support member. The outer ring member is arranged at the second opening. Two sides of the outer ring member respectively include a concave structure facing the first lens and a third opening. The outer ring member has an accommodation space between the concave structure and the third opening. The second lens is in the accommodation space, and is between the first lens and the third opening.

### CROSS-REFERENCE TO RELATED APPLICATION

This non-provisional application claims priority under 35 U.S.C. § 119(a) to Patent Application No. 202411996542.9 filed in China on Dec. 31, 2024, the entire contents of which are hereby incorporated by reference.

### BACKGROUND

### Technical Field

The present disclosure relates to a lens module and a camera device, and in particular, to a thin lens module applied to a camera device.

### Related Art

With the advancement of technologies, lens modules are widely used in electronic devices with a video function or a photographing function, such as cameras, mobile phones, tablet computers, or monitors. Currently, lenses in lens modules protrude from housings of mobile phones due to an excessively large height, impeding thinning of mobile phones.

### SUMMARY

In view of this, some embodiments of the present disclosure provide a lens module, including a substrate, a photosensitive assembly, a support member, a first lens, an actuator, an outer ring member, and a second lens. The photosensitive assembly is on the substrate. The support member is on the substrate and covers the photosensitive assembly, and the support member has a first opening. The first lens corresponds to the photosensitive assembly and is arranged at the first opening of the support member, and the photosensitive assembly is located between the first lens and the substrate. The actuator is on the support member, and the actuator has a second opening. The outer ring member is arranged at the second opening of the actuator, and two sides of the outer ring member respectively include a concave structure facing the first lens and a third opening. The outer ring member has an accommodation space located between the concave structure and the third opening. The second lens is arranged within the accommodation space of the outer ring member, and is located between the first lens and the third opening of the outer ring member.

In some embodiments, a lens module is composed of a substrate, a photosensitive assembly, a support member, a first lens, an actuator, an outer ring member, and a second lens. The photosensitive assembly is on the substrate. The support member is on the substrate and covers the photosensitive assembly, and the support member has a first opening. The first lens corresponds to the photosensitive assembly and is arranged at the first opening of the support member, and the photosensitive assembly is located between the first lens and the substrate. The actuator is on the support member, and the actuator has a second opening. The outer ring member is arranged at the second opening of the actuator, and two sides of the outer ring member respectively include a concave structure facing the first lens and a third opening. The outer ring member has an accommodation space located between the concave structure and the third opening. The second lens is arranged within the accommodation space of the outer ring member, and is located between the first lens and the third opening of the outer ring member.

In some embodiments, a camera device includes a housing, a protective cover, a substrate, a photosensitive assembly, a support member, a first lens, an actuator, an outer ring member, and a second lens. A side of the housing has a through hole. The protective cover is arranged at the through hole of the housing, and has a light filtering function. The substrate is on a side of the housing away from the through hole. The photosensitive assembly is on the substrate. The support member is on the substrate and covers the photosensitive assembly, and the support member has a first opening. The first lens corresponds to the photosensitive assembly and is arranged at the first opening of the support member, and the photosensitive assembly is located between the first lens and the substrate. The actuator is on the support member, and the actuator has a second opening. The outer ring member is arranged at the second opening of the actuator, and two sides of the outer ring member respectively include a concave structure facing the first lens and a third opening. The outer ring member has an accommodation space located between the concave structure and the third opening. The second lens is arranged within the accommodation space of the outer ring member, and is located between the first lens and the third opening of the outer ring member.

In some embodiments, the protective cover has a light filtering layer.

In some embodiments, the support member includes a fixed portion and a bearing portion. One end of the fixed portion is on the substrate. The bearing portion is connected to an other end of the fixed portion, and an other end away from the fixed portion contacts the first lens. The fixed portion is on the substrate to surround the photosensitive assembly, and the bearing portion is located above a periphery of a photosensitive area of the photosensitive assembly, so that the first lens, the substrate, and the support member form a closed space.

In some embodiments, the first lens includes a lens body and a rib portion, and the concave structure includes an inner top surface and at least one inner side wall. The lens body is located above the photosensitive assembly. One end of the rib portion is connected to the lens body, and an other end contacts the support member. The inner top surface has a port in communication with the accommodation space. The at least one inner side wall is vertically connected to the inner top surface. A first height difference exists between the rib portion of the first lens and the inner top surface of the concave structure. A second height difference exists between a lower surface of the second lens extending through the port and the lens body of the first lens.

In some embodiments, the support member includes a bearing portion, the bearing portion has a first surface, a second surface, and a side surface, and an outer side of the rib portion of the first lens is fixed to the side surface.

In some embodiments, the support member includes the bearing portion and further includes a first limiting portion. The outer side of the rib portion of the first lens is fixed to the side surface of the bearing portion, and the first limiting portion is vertically arranged on the first surface of the bearing portion and contacts a lower edge of the rib portion of the first lens.

In some embodiments, the support member includes the bearing portion and the first limiting portion and further includes a second limiting portion. The outer side of the rib portion of the first lens is fixed to the side surface of the bearing portion, the first limiting portion is vertically arranged on the first surface of the bearing portion and contacts a lower edge of the rib portion of the first lens, the second limiting portion is vertically arranged on the second surface of the bearing portion, and an axis of the second limiting portion perpendicular to the second surface is located outside the outer ring member.

In some other embodiments, the support member includes a bearing portion, the bearing portion has a first surface and a second surface, and the second surface contacts a lower edge of the rib portion of the first lens.

In some other embodiments, the support member includes the bearing portion and further includes a first limiting portion. The second surface of the bearing portion contacts the lower edge of the rib portion of the first lens, the first limiting portion is vertically arranged on the second surface of the bearing portion, and an axis of the first limiting portion perpendicular to the second surface is located outside the rib portion of the first lens.

In some other embodiments, the support member includes the bearing portion and further includes a first limiting portion. The second surface of the bearing portion contacts the lower edge of the rib portion of the first lens, the first limiting portion is vertically arranged on the second surface of the bearing portion, and the axis of the first limiting portion perpendicular to the second surface is located outside the rib portion of the first lens. Moreover, the first limiting portion contacts a side of the rib portion of the first lens and is located inside the outer ring member.

In some other embodiments, the support member includes the bearing portion and the first limiting portion and further includes a second limiting portion. The second surface of the bearing portion contacts the lower edge of the rib portion of the first lens, the first limiting portion and the second limiting portion are vertically arranged on the second surface of the bearing portion, the first limiting portion contacts the side of the rib portion of the first lens and is located inside the outer ring member, and the axis of the second limiting portion perpendicular to the second surface is located outside the outer ring member.

In some embodiments, the concave structure has a first width, the first lens has a second width, and the first width is greater than the second width.

In summary, according to the lens module provided in any embodiments of the present disclosure, the optical filter located between the first lens and the photosensitive assembly is omitted, and the first lens is on the support member to form the closed space composed of the support member, the substrate, and the first lens, to prevent dust from contaminating the photosensitive assembly and reduce an overall height of the lens module, thereby providing a thin lens module. In some embodiments, the foregoing lens module is applied to a camera device, and the camera device uses the protective cover having a light filtering function instead of the optical filter, to reduce the overall height of the camera device, thereby providing a thin camera device.

### BRIEF DESCRIPTION OF THE DRAWINGS

FIG. 1 is a schematic appearance diagram of a lens module applied to a camera device.

FIG. 2 is a partial schematic side view along a line II-II in FIG. 1.

FIG. 3 is a schematic top diagram of a lens module according to an embodiment of the present disclosure.

FIG. 4 is a schematic front exploded view of the lens module according to an embodiment of the present disclosure.

FIG. 5 is a schematic cross-sectional view of the lens module along a sectional line V-V in FIG. 3.

FIG. 6 is a schematic sectional view of the lens module according to an embodiment of the present disclosure.

FIG. 7 is a schematic diagram of relative positions of a first lens, an outer ring member, and a support member in a first implementation marked by a dashed-line box H in FIG. 6.

FIG. 8 is a schematic diagram of relative positions of the first lens, the outer ring member, and a support member in a second implementation marked by a dashed-line box H in FIG. 6.

FIG. 9 is a schematic diagram of relative positions of the first lens, the outer ring member, and a support member in a third implementation marked by a dashed-line box H in FIG. 6.

FIG. 10 is a schematic diagram of relative positions of the first lens, the outer ring member, and a support member in a fourth implementation marked by a dashed-line box H in FIG. 6.

FIG. 11 is a schematic diagram of relative positions of the first lens, the outer ring member, and a support member in a fifth implementation marked by a dashed-line box H in FIG. 6.

FIG. 12 is a schematic diagram of relative positions of the first lens, the outer ring member, and a support member in a sixth implementation marked by a dashed-line box H in FIG. 6.

FIG. 13 is a schematic diagram of relative positions of the first lens, the outer ring member, and a support member in a seventh implementation marked by a dashed-line box H in FIG. 6.

### DETAILED DESCRIPTION

In the following embodiments, unless specially described as an electrical connection, terms regarding connection may refer to a physical connection or a direct connection or an indirect connection between physical assemblies. It should be particularly noted that the following terms “first” and “second” are merely used for description and should not be understood as indicating or implying relative importance.

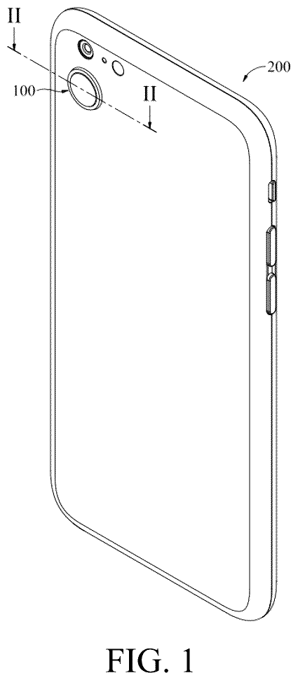

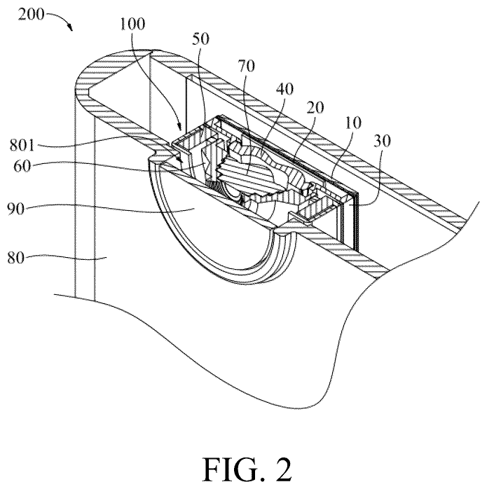

Referring to FIG. 1 and FIG. 2, a lens module 100 may be applied to a camera device 200. In some embodiments, the camera device 200 includes a housing 80, a protective cover 90, and the lens module 100. A side of the housing 80 has a through hole 801, and the protective cover 90 is arranged at the through hole 801 of the housing 80. The lens module 100 is arranged on a side of the housing 80 away from the through hole 801 through a substrate 10.

For example, the lens module 100 may be used as a front lens, a main lens, a wide-angle lens, or a telephoto lens of a mobile phone. The camera device 200 may be mounted in an electronic device as a photographing assembly. For example, the electronic device may be a smart phone, a wearable apparatus, a tablet computer, a camera, a pad device, or a monitor.

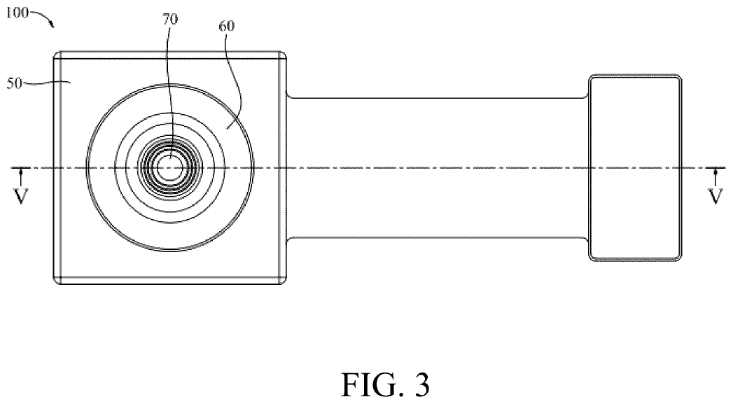

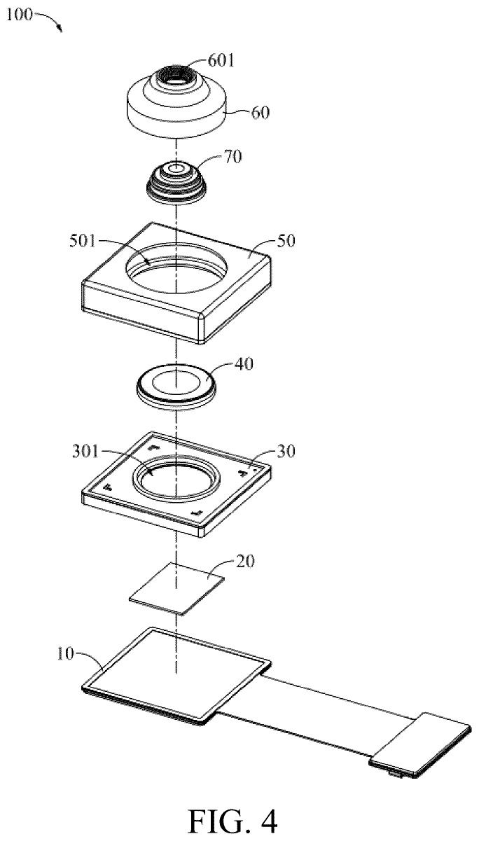

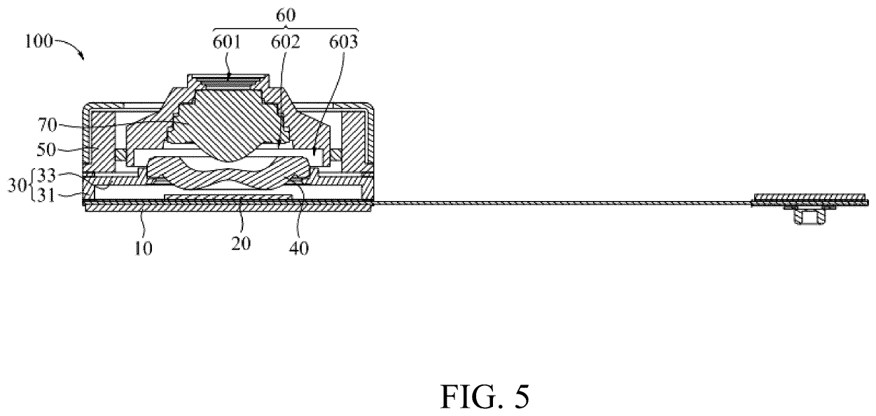

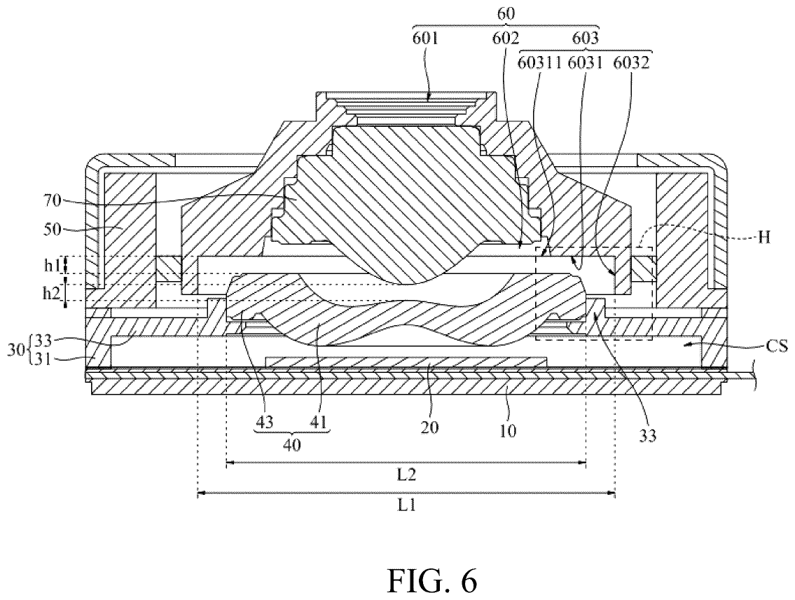

Referring to FIG. 3 to FIG. 6, FIG. 3 is a schematic top diagram of the lens module 100, FIG. 4 is a schematic front exploded view of the lens module 100, and FIG. 5 to FIG. 6 are schematic sectional views of the lens module 100. In some embodiments, the lens module 100 includes a substrate 10, a photosensitive assembly 20, a support member 30, a first lens 40, an actuator 50, an outer ring member 60, and a second lens 70. The support member 30 has a first opening 301 (i.e., a through hole). The actuator 50 has a second opening 501 (i.e., a through hole). Two sides of the outer ring member 60 respectively include a concave structure 603 facing the first lens 40 and a third opening 601 (i.e., a through hole). The outer ring member 60 has an accommodation space 602 located between the concave structure 603 and the third opening 601.

In some examples, the lens module 100 is composed of the substrate 10, the photosensitive assembly 20, the support member 30, the first lens 40, the actuator 50, the outer ring member 60, and the second lens 70. The photosensitive assembly 20 is located on the substrate 10. The support member 30 is arranged on the substrate 10 and covers the photosensitive assembly 20, and the support member 30 has the first opening 301. The first lens 40 corresponds to the photosensitive assembly 20 and is arranged at the first opening 301 of the support member 30, and the photosensitive assembly 20 is located between the first lens 40 and the substrate 10. The actuator 50 is located on the support member 30, and the actuator 50 has the second opening 501. The outer ring member 60 is arranged at the second opening 501 of the actuator 50, and the two sides of the outer ring member 60 respectively include the concave structure 603 facing the first lens 40 and the third opening 601. The outer ring member 60 has the accommodation space 602 located between the concave structure 603 and the third opening 601. The second lens 70 is arranged within the accommodation space 602 of the outer ring member 60, and is located between the first lens 40 and the third opening 601 of the outer ring member 60.

One end of the substrate 10 is provided with the photosensitive assembly 20 and the support member 30, so as to be covered by assemblies such as the first lens 40, the actuator 50, the outer ring member 60, and the second lens 70, and an other end extends outward to be connected to an external device. For example, when the lens module 100 is applied to the camera device 200, one end of the substrate 10 is provided with assemblies such as the substrate 10, the photosensitive assembly 20, the support member 30, the first lens 40, the actuator 50, the outer ring member 60, and the second lens 70, and an other end is located on the housing 80 of the camera device 200, as shown in FIG. 1 and FIG. 2. In some embodiments, the substrate 10 may be a flexible substrate or a silicon substrate.

The photosensitive assembly 20 is located on the substrate 10. The substrate 10 is conductive, and the photosensitive assembly 20 is electrically connected to the substrate 10. For example, the photosensitive assembly 20 is coupled to a conductive circuit of the substrate 10, and an electrical signal from a circuit outside the camera device 200 may be transmitted to the photosensitive assembly 20 through an internal circuit of the substrate 10. In some embodiments, the photosensitive assembly 20 may be a complementary metal-oxide-semiconductor (CMOS) image sensor (CIS). In some embodiments, the photosensitive assembly 20 may be electrically connected to the inner substrate 10 through flip chip packaging or a surface-mount technology (SMT). In some embodiments, the photosensitive assembly 20 includes a photosensitive area and a non-photosensitive area (not shown in the figures), and the non-photosensitive area is located at a periphery of the photosensitive area.

Moreover, the photosensitive assembly 20 can convert an optical image signal incident on the photosensitive assembly 20 into an electrical image signal. For example, the optical image signal is emitted from outside of the camera device 200, passes through the protective cover 90, the second lens 70, and the first lens 40, and then enters the photosensitive area of the photosensitive assembly 20, where the photosensitive area is an area used for optical sensing.

The support member 30 is arranged on the substrate 10 and covers the photosensitive assembly 20. For example, the support member 30 is arranged on the substrate 10 on an outer side of the photosensitive assembly 20. The support member 30 is configured to support the first lens 40 and the actuator 50. In some embodiments, the support member 30 has an annular structure and is arranged on the substrate 10 at the outer side of the photosensitive assembly 20 in a surrounding manner. In some embodiments, a quantity of support members 30 may be adjusted based on actual applications. In other words, one or more support members 30 may be arranged.

The support member 30 has the first opening 301 located above the photosensitive area of the photosensitive assembly 20, so that an external light source can enter the photosensitive assembly 20 through the first opening 301.

In some embodiments, the support member 30 includes a fixed portion 31 and a bearing portion 33. One end of the fixed portion 31 is arranged on the substrate 10, and an other end is connected to the bearing portion 33. In other words, the fixed portion 31 and the bearing portion 33 are perpendicular to each other. Moreover, the fixed portion 31 is arranged on the substrate 10 to surround the photosensitive assembly 20, and the bearing portion 33 is located above a periphery of the photosensitive area (i.e., the non-photosensitive area) of the photosensitive assembly 20. In some embodiments, the fixed portion 31 and the bearing portion 33 may be integrally formed, or may be separate individual assemblies connected to each other through assembly to form the support member 30.

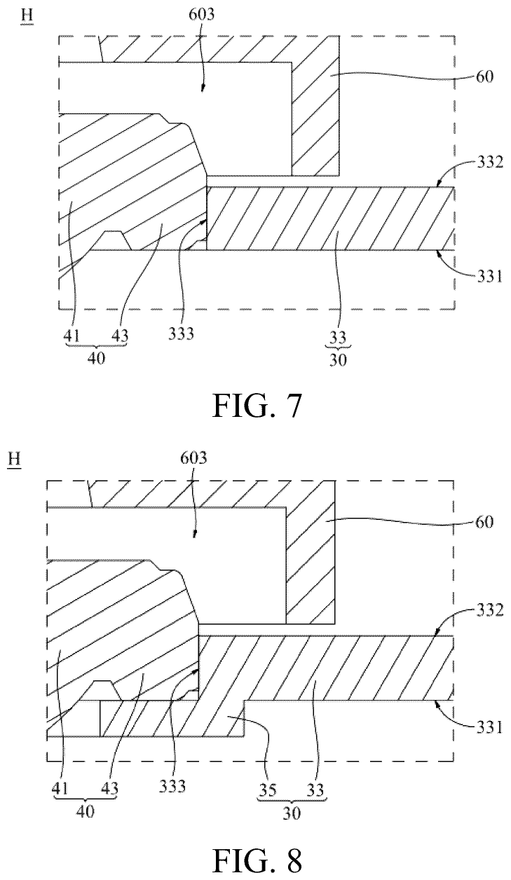

In some embodiments, the bearing portion 33 has a first surface 331, a second surface 332, and a side surface 333, as shown in FIG. 7 to FIG. 13. The first surface 331 is an inner side wall surface and is a surface of the bearing portion 33 adjacent to the photosensitive assembly 20, and the second surface 332 is an outer side wall surface and is a surface of the bearing portion 33 adjacent to the outer ring member 60. The first surface 331 and the second surface 332 are parallel to each other and are connected by the side surface 333 (i.e., a hole wall of the first opening 301). Moreover, the side surface 333 is vertically connected to the first surface 331 and the second surface 332.

In some other embodiments, the support member 30 further includes a limiting portion (defined as a first limiting portion 35) in addition to the fixed portion 31 and the bearing portion 33. The first limiting portion 35 is connected to the bearing portion 33. For example, the first limiting portion 35 is vertically arranged on the first surface 331 or the second surface 332 of the bearing portion 33. In some embodiments, the fixed portion 31, the bearing portion 33, and the first limiting portion 35 may be integrally formed, or may be separate individual assemblies connected to each other through assembly to form the support member 30.

In some still other embodiments, the support member 30 further includes a plurality of limiting portions (defined as the first limiting portion 35 and a second limiting portion 37) in addition to the fixed portion 31 and the bearing portion 33. Both the first limiting portion 35 and the second limiting portion 37 are connected to the bearing portion 33. For example, the first limiting portion 35 is vertically arranged on the first surface 331 or the second surface 332 of the bearing portion 33, and the second limiting portion 37 is vertically arranged on the second surface 332 of the bearing portion 33 and an axis thereof arranged perpendicular to the second surface 332 is located outside the outer ring member 60. In some embodiments, the fixed portion 31, the bearing portion 33, the first limiting portion 35, and the second limiting portion 37 may be integrally formed, or may be separate individual assemblies connected to each other through assembly to form the support member 30.

The first lens 40 corresponds to the photosensitive assembly 20 and is arranged at the first opening 301 of the support member 30. Therefore, the photosensitive assembly 20 is located between the first lens 40 and the substrate 10. In some embodiments, the first lens 40 includes a lens body 41 and a rib portion 43, as shown in FIG. 7 to FIG. 13. The lens body 41 is located above the photosensitive assembly 20, one end of the rib portion 43 is connected to the lens body 41, and an other end contacts the support member 30. In some embodiments, a minimum distance between a lower edge of the lens body 41 and the photosensitive assembly 20 is not less than 0 millimeters (mm).

As shown in FIG. 4, the first lens 40 is in a shape of circle, but it may alternatively be in a shape of an ellipsis, a square, or any curved surface, which is not limited thereto. As shown in FIG. 5 and FIG. 6, the first lens 40 may be, but is not limited to, a plate lens, a spherical convex lens, a spherical concave lens, a parabolic convex lens, a parabolic concave lens, or a freeform surface lens. In some embodiments, the first lens 40 may be made of glass or plastic.

Referring to FIG. 6, in some embodiments, the first lens 40, the substrate 10, and the support member 30 may form a closed space CS. For example, the fixed portion 31 of the support member 30 surrounds the photosensitive assembly 20 and has one end arranged on the substrate 10 and an other end connected to the bearing portion 33. The bearing portion 33 perpendicular to the fixed portion 31 is located above a periphery of the photosensitive area of the photosensitive assembly 20, and the first lens 40 contacts an other end of the bearing portion 33 away from the fixed portion 31. In other words, the first lens 40 covers the photosensitive area of the photosensitive assembly 20, and the bearing portion 33 of the support member 30 covers the non-photosensitive area of the photosensitive assembly 20. In this way, the first lens 40, the substrate 10, and the support member 30 form the closed space CS.

In some embodiments, the support member 30 includes the fixed portion 31 and the bearing portion 33, and the support member 30 supports or fixes the first lens 40 through the bearing portion 33. For example, the rib portion 43 of the first lens 40 is fixed to the second surface 332 or the side surface 333 of the bearing portion 33 by an adhesive or another connection mean, so that the first lens 40, the substrate 10, and the support member 30 form the closed space CS. Based on this, the bearing portion 33 may be configured to support or fix the first lens 40 and to prevent external dust from entering the closed space CS.

In other embodiments, the support member 30 further includes a first limiting portion 35 in addition to the fixed portion 31 and the bearing portion 33, and the first limiting portion 35 is vertically arranged on the first surface 331 or the second surface 332 of the bearing portion 33. The first lens 40 contacts both the bearing portion 33 and the first limiting portion 35, so that the first lens 40, the substrate 10, and the support member 30 form the closed space CS. In this case, the first limiting portion 35 may be configured to limit and/or reinforce the support for the first lens 40, or may serve as a baffle to block external contamination.

In still other embodiments, the support member 30 further includes a first limiting portion 35 and a second limiting portion 37 in addition to the fixed portion 31 and the bearing portion 33. The first limiting portion 35 is vertically arranged on the first surface 331 or the second surface 332 of the bearing portion 33, and the second limiting portion 37 is vertically arranged on the second surface 332 of the bearing portion 33. The first lens 40 contacts the bearing portion 33 and the first limiting portion 35, so that the first lens 40, the substrate 10, and the support member 30 form the closed space CS, while the second limiting portion does not contact the first lens 40. In this case, the first limiting portion 35 may be configured to limit and/or support the first lens 40, and the second limiting portion 37 may serve as a baffle to block external contamination and limit the outer ring member 60.

The actuator 50 is located on the support member 30. In this case, the actuator 50 is configured to drive the outer ring member 60 to cause the second lens 70 to move in a direction perpendicular to the photosensitive assembly 20 for focusing. In some embodiments, the actuator 50 may have an optical image stabilization function. The actuator 50 may be a voice coil motor (VCM), but is not limited thereto. In some embodiments, the actuator 50 may be a stepper motor, a micro-piezoelectric actuator, or a shape memory alloy (SMA) motor.

The actuator 50 has a second opening 501. Specifically, the actuator 50 may be an annular or frame-like structure to form the second opening 501. Referring to FIG. 4, the outer ring member 60 may be arranged at the second opening 501 of the actuator 50 and connected to a side wall of the actuator 50 that forms the second opening 501. In some embodiments, the outer ring member 60 moves up and down within the second opening 501 through an actuator support (not shown in the figure).

The outer ring member 60 is arranged at the second opening 501 of the actuator 50, and the two sides of the outer ring member 60 respectively include the concave structure 603 facing the first lens 40 and the third opening 601. The outer ring member 60 has the accommodation space 602 located between the concave structure 603 and the third opening 601. Referring to FIG. 5 and FIG. 6, the concave structure 603 is located on a side adjacent to the first lens 40, and the third opening 601 is located on an other side away from the first lens 40. The accommodation space 602 may be in a shape of an arc, a recess, a step, to accommodate at least one second lens 70.

Referring to FIG. 6, the concave structure 603 includes an inner top surface 6031 and at least one inner side wall 6032. Moreover, the inner top surface 6031 has a port 60311 in communication with the accommodation space 602, and the at least one inner side wall 6032 is vertically connected to the inner top surface 6031. Specifically, the inner top surface 6031 and its port 60311 are located on an end of the concave structure 603 away from the first lens 40.

In some embodiments, the concave structure 603 of the outer ring member 60 covers the first lens 40, and the inner side wall 6032 of the concave structure 603 is close to but does not contact the second surface 332 of the bearing portion 33.

In some embodiments, a first height difference h1 exists between the rib portion 43 of the first lens 40 and the inner top surface 6031 of the concave structure 603, as shown in FIG. 6. For example, the first height difference h1 is not less than 0.10 mm and less than 0.55 mm. For example, the first height difference h1 is 0.10 mm, 0.11 mm, 0.12 mm, 0.13 mm, 0.14 mm, 0.15 mm, 0.16 mm, 0.17 mm, 0.18 mm, 0.19 mm, 0.20 mm, 0.21 mm, 0.22 mm, 0.23 mm, 0.24 mm, 0.25 mm, 0.26 mm, 0.27 mm, 0.28 mm, 0.29 mm, 0.30 mm, 0.31 mm, 0.32 mm, 0.33 mm, 0.34 mm, 0.35 mm, 0.36 mm, 0.37 mm, 0.38 mm, 0.39 mm, 0.40 mm, 0.41 mm, 0.42 mm, 0.43 mm, 0.44 mm, 0.45 mm, 0.46 mm, 0.47 mm, 0.48 mm, 0.49 mm, 0.50 mm, 0.51 mm, 0.52 mm, 0.53 mm, or 0.54 mm. In an example, when the outer ring member 60 is at an initial position of the actuator 50 (i.e., a position where the outer ring member 60 and the support member 30 have a smallest distance on a virtual vertical line), the first height difference h1 is 0.27±0.02 mm.

Referring to FIG. 6, in some embodiments, the concave structure 603 has a first width L1, the first lens 40 has a second width L2, and the first width L1 is greater than the second width L2. For example, the first width L1 and the second width L2 are not less than 0.10 mm but not greater than 15 mm. In an exemplary embodiment, the first width L1 is 6.5±0.02 mm, and the second width L2 is 5.6±0.02 mm.

The second lens 70 is arranged within the accommodation space 602 of the outer ring member 60, and is located between the first lens 40 and the third opening 601 of the outer ring member 60. In other words, an optical signal from outside sequentially passes through the third opening 601, the second lens 70, and the first lens 40, and is then received by the photosensitive assembly 20.

As shown in FIG. 4, the second lens 70 is in a shape of circle, but it may alternatively be in a shape of an ellipsis, a square, or any curved surface, which is not limited thereto. As shown in FIG. 5 and FIG. 6, the second lens 70 may be, but is not limited to, a plate lens, a spherical convex lens, a spherical concave lens, a parabolic convex lens, a parabolic concave lens, or a freeform surface lens. In some embodiments, the second lens 70 may be made of glass or plastic.

In some embodiments, the second lens 70 is arranged within the accommodation space 602 of the outer ring member 60, and a part of the second lens 70 extends through the port 60311 and is located within the concave structure 603. A second height difference h2 exists between a lower surface of the second lens 70 and the lens body 41 of the first lens 40, as shown in FIG. 6. For example, the second height difference h2 is not less than 0.1 mm and not greater than 0.5 mm. For example, the second height difference h2 is 0.10 mm, 0.11 mm, 0.12 mm, 0.13 mm, 0.14 mm, 0.15 mm, 0.16 mm, 0.17 mm, 0.18 mm, 0.19 mm, 0.20 mm, 0.21 mm, 0.22 mm, 0.23 mm, 0.24 mm, 0.25 mm, 0.26 mm, 0.27 mm, 0.28 mm, 0.29 mm, 0.30 mm, 0.31 mm, 0.32 mm, 0.33 mm, 0.34 mm, 0.35 mm, 0.36 mm, 0.37 mm, 0.38 mm, 0.39 mm, 0.40 mm, 0.41 mm, 0.42 mm, 0.43 mm, 0.44 mm, 0.45 mm, 0.46 mm, 0.47 mm, 0.48 mm, 0.49 mm, or 0.50 mm. In an exemplary embodiment, when the outer ring member 60 is at the initial position of the actuator 50 (i.e., the position where the outer ring member 60 and the support member 30 have a smallest distance on the virtual vertical line), the second height difference h2 is 0.25 mm.

Referring to FIG. 5 and FIG. 6, in some embodiments, the photosensitive assembly 20 and the support member 30 are arranged on the substrate 10. The support member 30 is vertically arranged on the substrate 10 on an outer side of the photosensitive assembly 20 by its fixed portion 31, and surrounds a periphery of the photosensitive assembly 20. The support member 30 includes the fixed portion 31, the bearing portion 33, and the first limiting portion 35. The first lens 40 is arranged on the first limiting portion 35 and contacts the side surface 333 of the bearing portion 33, so that the first lens 40, the support member 30, and the substrate 10 form the closed space CS, which can prevent external dust from contaminating the photosensitive assembly 20. The actuator 50 having the second opening 501 is arranged on the bearing portion 33 of the support member 30 and is connected to the outer ring member 60. The outer ring member 60 is arranged at the second opening 501 of the actuator 50. The concave structure 603 is arranged on a side of the outer ring member facing the first lens 40. The concave structure 603 covers the first lens 40. The third opening 601 is provided on an other side of the outer ring member 60 opposite to the first lens 40, and the accommodation space 602 is provided between the third opening 601 and the concave structure 603, in which the second lens 70 is arranged. A lower edge of the inner side wall 6032 of the concave structure 603 is close to but does not contact the second surface 332 of the bearing portion 33. The lower edge of the second lens 70 extends through the port 60311 of the concave structure 603 and is close to but does not contact the lens body 41 of the first lens 40. In addition, an axis of the first limiting portion 35 of the support member 30 perpendicular to the second surface 332 is located inside the outer ring member 60. In other words, the axis is located between the inner side wall 6032 of the concave structure 603 and the rib portion 43 of the first lens 40. In this way, the first limiting portion 35 can reduce a probability that external dust enters the outer ring member 60 and contaminates the first lens 40.

Refer again to FIG. 6 and refer to FIG. 7 to FIG. 13. A dashed-line box H in FIG. 6 indicates an area where the relative positions of the first lens 40, the support member 30, and the outer ring member 60 are located. FIG. 7 to FIG. 13 are schematic diagrams of relative positions between the support member 30 in different implementations (i.e., from a first implementation to a seventh implementation) and the first lens 40 and the outer ring member 60. An implementation of the support member 30 illustrated in FIG. 6 corresponds to a support member 30 in the sixth implementation shown in FIG. 12.

Referring to FIG. 7, in some embodiments of the support member 30 in the first implementation, the support member 30 includes the fixed portion 31 (not shown in the figure) and the bearing portion 33, and an outer side of the rib portion 43 of the first lens 40 is fixed to the side surface 333 of the bearing portion 33. The concave structure 603 of the outer ring member 60 covers the first lens 40 and a part of the bearing portion 33, and the lower edge of the inner side wall 6032 of the outer ring member 60 is close to but does not contact the second surface 332 of the bearing portion 33. In this way, the inner side wall 6032 of the outer ring member 60 can reduce the probability that external dust enters the concave structure 603 and contaminates the first lens 40. Moreover, since the first lens 40 may be fixed to the side surface 333 of the bearing portion 33, a distance between the inner top surface 6031 of the concave structure 603 and the second surface 332 can be reduced.

Referring to FIG. 8, in some embodiments the support member 30 in the second implementation, the support member 30 includes the fixed portion 31 (not shown in the figure), the bearing portion 33, and the first limiting portion 35, and the first limiting portion 35 is vertically arranged on the first surface 331 of the bearing portion 33. The outer side of the rib portion 43 of the first lens 40 is fixed to the side surface 333 of the bearing portion 33, and the first limiting portion 35 contacts the lower edge of the rib portion 43 of the first lens 40, thereby reinforcing support and limiting the first lens 40. The concave structure 603 of the outer ring member 60 covers the first lens 40 and a part of the bearing portion 33, and the lower edge of the inner side wall 6032 of the outer ring member 60 is close to but does not contact the second surface 332 of the bearing portion 33. In this way, the inner side wall 6032 of the outer ring member 60 can reduce the probability that external dust enters the concave structure 603 and contaminates the first lens 40. Moreover, since the first lens 40 may be supported by the first limiting portion 35, the distance between the inner top surface 6031 of the concave structure 603 and the second surface 332 can be reduced.

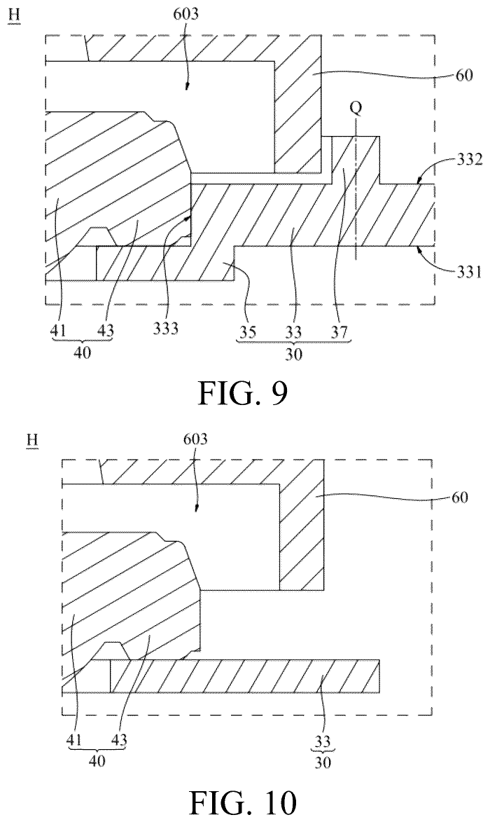

Referring to FIG. 9, in some embodiments of the support member 30 in the third implementation, the support member 30 includes the fixed portion 31 (not shown in the figure), the bearing portion 33, the first limiting portion 35, and the second limiting portion 37. The outer side of the rib portion 43 of the first lens 40 is fixed to the side surface 333 of the bearing portion 33. The first limiting portion 35 is vertically arranged on the first surface 331 of the bearing portion 33 and contacts the lower edge of the rib portion 43 of the first lens 40, thereby reinforcing support and limiting the first lens 40. The second limiting portion 37 is vertically arranged on the second surface 332 of the bearing portion 33, and an axis of the second limiting portion 37 perpendicular to the second surface 332 is located outside the outer ring member 60. The concave structure 603 of the outer ring member 60 covers the first lens 40, the first limiting portion 35, and a part of the bearing portion 33. The lower edge of the inner side wall 6032 of the outer ring member 60 is close to but does not contact the second surface 332 of the bearing portion 33, and the second limiting portion 37 is arranged outside the outer ring member 60. In this way, the inner side wall 6032 of the outer ring member 60 and the second limiting portion 37 can reduce the probability that external dust enters the concave structure 603 and contaminates the first lens 40. Moreover, since the first lens 40 may be supported by the first limiting portion 35, the distance between the inner top surface 6031 of the concave structure 603 and the second surface 332 can be reduced.

Referring to FIG. 10, in some embodiments of the support member 30 in the fourth implementation, the support member 30 includes the fixed portion 31 (not shown in the figure) and the bearing portion 33, and the lower edge of the rib portion 43 of the first lens 40 contacts the second surface 332 of the bearing portion 33. The concave structure 603 of the outer ring member 60 covers the first lens 40 and a part of the bearing portion 33, and the lower edge of the inner side wall 6032 of the outer ring member 60 is close to but does not contact the second surface 332 of the bearing portion 33. In this way, the inner side wall 6032 of the outer ring member 60 can reduce the probability that external dust enters the concave structure 603 and contaminates the first lens 40.

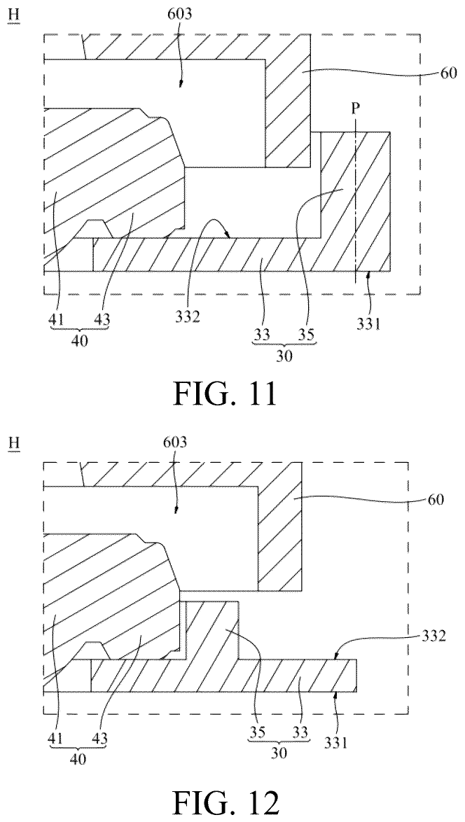

Referring to FIG. 11, in some embodiments of the support member 30 in the fifth implementation mode, the support member 30 includes the fixed portion 31 (not shown in the figure), the bearing portion 33, and the first limiting portion 35. The lower edge of the rib portion 43 of the first lens 40 contacts the second surface 332 of the bearing portion 33, and the first limiting portion 35 is vertically arranged on the second surface 332 of the bearing portion 33. Moreover, the axis of the first limiting portion 35 perpendicular to the second surface 332 is located outside the rib portion 43 of the first lens 40 and outside the outer ring member 60. The concave structure 603 of the outer ring member 60 covers the first lens 40 and a part of the bearing portion 33. The lower edge of the inner side wall 6032 of the outer ring member 60 is close to but does not contact the second surface 332 of the bearing portion 33, and the first limiting portion 35 is arranged outside the outer ring member 60. In this way, the inner side wall 6032 of the outer ring member 60 and the first limiting portion 35 can reduce the probability that external dust enters the concave structure 603 and contaminates the first lens 40, and the first limiting portion 35 located outside the outer ring member 60 can limit the outer ring member 60.

Referring to FIG. 12, in some embodiments of the support member 30 in the sixth implementation, the support member 30 includes the fixed portion 31 (not shown in the figure), the bearing portion 33, and the first limiting portion 35. The lower edge of the rib portion 43 of the first lens 40 contacts the second surface 332 of the bearing portion 33, and the first limiting portion 35 is vertically arranged on the second surface 332 of the bearing portion 33. Moreover, the axis of the first limiting portion 35 perpendicular to the second surface 332 is located outside the rib portion 43 of the first lens 40 and inside the outer ring member 60. The concave structure 603 of the outer ring member 60 covers the first lens 40, the first limiting portion 35, and a part of the bearing portion 33. The lower edge of the inner side wall 6032 of the outer ring member 60 is close to but does not contact the second surface 332 of the bearing portion 33 and a surface of the first limiting portion 35 facing the concave structure 603. In this way, the inner side wall 6032 of the outer ring member 60 and the first limiting portion 35 can reduce the probability that external dust enters the concave structure 603 and contaminates the first lens 40, and the first limiting portion 35 located inside the outer ring member 60 can limit the first lens 40.

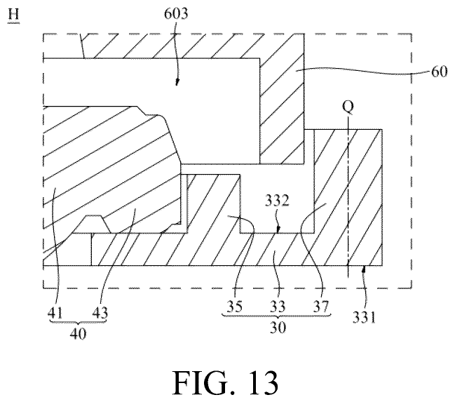

Referring to FIG. 13, in some embodiments of the support member 30 in the seventh implementation, the support member 30 includes the fixed portion 31 (not shown in the figure), the bearing portion 33, the first limiting portion 35, and the second limiting portion 37. The lower edge of the rib portion 43 of the first lens 40 contacts the second surface 332 of the bearing portion 33, and the first limiting portion 35 and the second limiting portion 37 are vertically arranged on the second surface 332 of the bearing portion 33. Moreover, the axis of the first limiting portion 35 perpendicular to the second surface 332 is located outside the rib portion 43 of the first lens 40 and inside the outer ring member 60, and the axis of the second limiting portion 37 perpendicular to the second surface 332 is located outside the rib portion 43 of the first lens 40 and outside the outer ring member 60. The concave structure 603 of the outer ring member 60 covers the first lens 40, the first limiting portion 35, and a part of the bearing portion 33, and the second limiting portion 37 is arranged outside the outer ring member 60. The lower edge of the inner side wall 6032 of the outer ring member 60 is close to but does not contact the second surface 332 of the bearing portion 33 and the surface of the first limiting portion 35 facing the concave structure 603. In this way, the inner side wall 6032 of the outer ring member 60 and the first limiting portion 35 can reduce the probability that external dust enters the concave structure 603 and contaminates the first lens 40, and the second limiting portion 37 located inside the outer ring member 60 can limit the outer ring member 60 and block contamination from external dust.

Referring again to FIG. 1 and FIG. 2, in some embodiments, the camera device 200 includes the housing 80, the protective cover 90, the substrate 10, the photosensitive assembly 20, the support member 30, the first lens 40, the actuator 50, the outer ring member 60, and the second lens 70. A side of the housing 80 has the through hole 801. The protective cover 90 is arranged at the through hole 801 of the housing 80 and has a light filtering function. The substrate 10 is arranged on the side of the housing 80 away from the through hole 801. The photosensitive assembly 20 is located on the substrate 10. The support member 30 is arranged on the substrate 10 and covers the photosensitive assembly 20, and the support member 30 has the first opening 301. The first lens 40 corresponds to the photosensitive assembly 20 and is arranged at the first opening 301 of the support member 30, and the photosensitive assembly 20 is located between the first lens 40 and the substrate 10. The actuator 50 is located on the support member 30, and the actuator 50 has the second opening 501. The outer ring member 60 is arranged at the second opening 501 of the actuator 50, and the two sides of the outer ring member 60 respectively include the concave structure 603 facing the first lens 40 and the third opening 601. The outer ring member 60 has the accommodation space 602 located between the concave structure 603 and the third opening 601. The second lens 70 is arranged within the accommodation space 602 of the outer ring member 60, and is located between the first lens 40 and the third opening 601 of the outer ring member 60.

The protective cover with a light filtering function provides a function of a traditional optical filter. For example, the protective cover 90 may be made of a coated plate lens, blue glass, or plastic. In some embodiments, the protective cover 90 has a light filtering layer. For example, the light filtering layer of the protective cover 90 may be formed by coating.

Referring to FIG. 2, the protective cover 90 is arranged at the through hole 801 of the housing 80, and the substrate 10 is arranged on the side of the housing 80 away from the through hole 801. It may be learned that an external light source passes through the protective cover 90 and then sequentially enters the third opening 601, the second lens 70, and the first lens 40, and is then received by the photosensitive assembly 20. Moreover, because the first lens 40 is arranged to replace a conventional optical filter arranged on the support member 30, the thickness of the outer ring member 60 where the second lens 70 is located can be reduced, thereby reducing the height of the protective cover 90 and thus reducing the overall height of the module.

In summary, according to the lens module 100 and the camera device 200 provided in any embodiment of this application, the arrangement of the first lens 40 on the support member 30 in different implementations reduces the overall height of the module and simplifies the assembly process. In addition, the closed space CS formed by the first lens 40, the support member 30, and the substrate 10 can prevent contamination from dust. In any embodiment, the protective cover of the camera device 200 with a light-filtering function can replace the conventional optical filter, which reduces parts to be assembled in the conventional lens module 100, thereby reducing the overall height of the module while maintaining the original functions.

What is claimed is:

1. A lens module, comprising:
a substrate;
a photosensitive assembly, on the substrate;
a support member, on the substrate and covering the photosensitive assembly, wherein the support member has a first opening;
a first lens, corresponding to the photosensitive assembly and arranged at the first opening of the support member, wherein the photosensitive assembly is located between the first lens and the substrate;
an actuator, on the support member, wherein the actuator has a second opening;
an outer ring member, arranged at the second opening of the actuator, wherein two sides of the outer ring member respectively comprise a concave structure facing the first lens and a third opening, and the outer ring member has an accommodation space located between the concave structure and the third opening; and
a second lens, arranged within the accommodation space of the outer ring member and located between the first lens and the third opening of the outer ring member.

2. The lens module according to claim 1, wherein the support member comprises:
a fixed portion, having one end on the substrate; and
a bearing portion, connected to an other end of the fixed portion, wherein an other end of the bearing portion away from the fixed portion contacts the first lens; and
the fixed portion is on the substrate to surround the photosensitive assembly, and the bearing portion is located above a periphery of a photosensitive area of the photosensitive assembly, so that the first lens, the substrate, and the support member form a closed space.

3. The lens module according to claim 1, wherein
the first lens comprises:
a lens body, located above the photosensitive assembly; and
a rib portion, having one end connected to the lens body and an other end contacting the support member; and
the concave structure comprises:
an inner top surface, having a port in communication with the accommodation space; and
at least one inner side wall, vertically connected to the inner top surface, wherein
a first height difference exists between the rib portion of the first lens and the inner top surface of the concave structure; and
a second height difference exists between a lower surface of the second lens extending through the port and the lens body of the first lens.

4. The lens module according to claim 3, wherein the support member comprises a bearing portion, the bearing portion has a first surface, a second surface, and a side surface, and an outer side of the rib portion of the first lens is fixed to the side surface.

5. The lens module according to claim 4, wherein the support member further comprises a first limiting portion, and the first limiting portion is vertically arranged on the first surface of the bearing portion and contacts a lower edge of the rib portion of the first lens.

6. The lens module according to claim 5, wherein the support member further comprises a second limiting portion, the second limiting portion is vertically arranged on the second surface of the bearing portion, and an axis of the second limiting portion perpendicular to the second surface is located outside the outer ring member.

7. The lens module according to claim 3, wherein the support member comprises a bearing portion, the bearing portion has a first surface and a second surface, and the second surface contacts a lower edge of the rib portion of the first lens.

8. The lens module according to claim 7, wherein the support member further comprises a first limiting portion, the first limiting portion is vertically arranged on the second surface of the bearing portion, and an axis of the first limiting portion perpendicular to the second surface is located outside the rib portion of the first lens.

9. The lens module according to claim 8, wherein the first limiting portion contacts a side of the rib portion of the first lens and is located inside the outer ring member.

10. The lens module according to claim 9, wherein the support member further comprises a second limiting portion, the second limiting portion is vertically arranged on the second surface of the bearing portion, and an axis of the second limiting portion perpendicular to the second surface is located outside the outer ring member.

11. The lens module according to claim 3, wherein the concave structure has a first width, the first lens has a second width, and the first width is greater than the second width.

12. A lens module, composed of a substrate, a photosensitive assembly, a support member, a first lens, an actuator, an outer ring member, and a second lens, wherein the photosensitive assembly is on the substrate;
the support member is on the substrate and covers the photosensitive assembly, and the support member has a first opening;
the first lens corresponds to the photosensitive assembly and is arranged at the first opening of the support member, and the photosensitive assembly is located between the first lens and the substrate;
the actuator is on the support member, and has a second opening;
the outer ring member is arranged at the second opening of the actuator, two sides of the outer ring member respectively comprise a concave structure facing the first lens and a third opening, and the outer ring member has an accommodation space located between the concave structure and the third opening; and
the second lens is arranged within the accommodation space of the outer ring member, and is located between the first lens and the third opening of the outer ring member.

13. The lens module according to claim 12, wherein the support member comprises:
a fixed portion, having one end on the substrate; and
a bearing portion, connected to an other end of the fixed portion, wherein an other end of the bearing portion away from the fixed portion contacts the first lens; and
the fixed portion is on the substrate to surround the photosensitive assembly, and the bearing portion is located above a periphery of a photosensitive area of the photosensitive assembly, so that the first lens, the substrate, and the support member form a closed space.

14. A camera device, comprising:
a housing, wherein a side of the housing has a through hole;
a protective cover, arranged at the through hole of the housing, wherein the protective cover has a light filtering function;
a substrate, on a side of the housing away from the through hole;
a photosensitive assembly, on the substrate;
a support member, on the substrate and covering the photosensitive assembly, wherein the support member has a first opening;
a first lens, corresponding to the photosensitive assembly and arranged at the first opening of the support member, wherein the photosensitive assembly is located between the first lens and the substrate;
an actuator, on the support member, wherein the actuator has a second opening;
an outer ring member, arranged at the second opening of the actuator, wherein two sides of the outer ring member respectively comprise a concave structure facing the first lens and a third opening facing the protective cover, and the outer ring member has an accommodation space located between the concave structure and the third opening; and
a second lens, arranged within the accommodation space of the outer ring member, located between the first lens and the third opening of the outer ring member.

15. The camera device according to claim 14, wherein the protective cover has a light filtering layer.

16. The camera device according to claim 14, wherein the support member comprises:
a fixed portion, having one end on the substrate; and
a bearing portion, connected to an other end of the fixed portion, wherein an other end of the bearing portion away from the fixed portion contacts the first lens; and
the fixed portion is on the substrate to surround the photosensitive assembly, and the bearing portion is located above a periphery of a photosensitive area of the photosensitive assembly, so that the first lens, the substrate, and the support member form a closed space.
